(19) United States
(12) Patent Application Publication
(10) Pub. No.: US 2024/0289194 A1
(43) Pub. Date: Aug. 29, 2024

(54) DEVICE AND METHOD FOR PERFORMING DATA COMMUNICATION BETWEEN MULTIPLE APPLICATIONS

(71) Applicant: Hanwha Vision Co., Ltd., Seongnam-si (KR)

(72) Inventors: Hye Ri KIM, Seongnam-si (KR); Min Gi LEEM, Seongnam-si (KR); Young Hun HONG, Seongnam-si (KR)

(73) Assignee: Hanwha Vision Co., Ltd., Seongnam-si (KR)

(21) Appl. No.: 18/697,331

(22) PCT Filed: Sep. 21, 2022
(86) PCT No.: PCT/KR2022/014102

§ 371 Date: Mar. 29, 2024

(30) Foreign Application Priority Data
Oct. 26, 2021 (KR) 10-2021-0144006

(51) Int. Cl. G06F 9/54

(52) U.S. Cl. CPC G06F 9/544; G06F 9/541; G06F 9/542

(57) ABSTRACT

The present disclosure relates to a computing device for performing data communication between a plurality of applications by using an application programming interface (API). According to the present disclosure, a computing device includes a first application memory storing a master application that transfers shared information to a shared memory by using a first memory function, a second application memory storing a slave application that receives the shared information from the shared memory by using a second memory function, and the shared memory connected between the first application memory and the second application memory and configured to transfer the shared information between the master application and the slave application.

### TECHNICAL FIELD

The present disclosure relates to, generally, a method of performing data communication between applications by using an application programming interface (API), and more particularly, to an apparatus and method of sharing data between applications by using a shared memory.

### BACKGROUND ART

Embedded devices refer to a programmable device made to perform a specific purpose. A network camera, as an example of embedded devices, refers to a camera that is connected to the Internet and has a function to transfer image data to a server or an apparatus that displays an image. In other words, a network camera may perform an application by using an application programming interface (API) and process the image data obtained through the application or transfer the image data to another embedded device.

Furthermore, the network camera may perform the overall operation of the network camera by using a plurality of applications. The plurality of applications may include applications for performing all functions of a network camera, such as an application for transceiving data through a communication network, an application for processing image data within a network camera, and the like. In order for the plurality of applications to be efficiently operated, there is a need for sharing data between the plurality of applications.

According to the related art, direct data communication may not be made between a plurality of applications of a network camera. In other words, the network camera, when needing data sharing between a plurality of applications, has no choice but to use socket communication through a main controller such as a separate processor. When socket communication using a main controller is used, the structure of data communication becomes complicated and the processing time increases. Accordingly, recently, the development of technology to quickly share data between applications without using the main controller is required.

The aforementioned technology is technical information possessed by the inventor for derivation of the present disclosure or acquired by the inventor during the derivation of the present disclosure, and is not necessarily prior art disclosed to the public before the application of the present disclosure.

### DISCLOSURE

### Technical Problem

Based on the descriptions presented above, the present disclosure provides an apparatus and method of performing data communication between a plurality of applications by using an application programming interface (API).

Furthermore, the present disclosure provides an apparatus and method of sharing data between a plurality of applications based on data sharing by using a shared memory.

Furthermore, the present disclosure provides an apparatus and method of identifying whether pieces of data are effectively transferred, based on data sharing by using a shared memory.

### Technical Solution

According to various embodiments of the present disclosure, a computing device for performing data communication between a plurality of applications by using an application programming interface (API) includes a first application memory storing a master application that transfers shared information to a shared memory by using a first memory function, a second application memory storing a slave application that receives the shared information from the shared memory by using a second memory function, and the shared memory connected between the first application memory and the second application memory and configured to transfer the shared information between the master application and the slave application.

According to an embodiment, the shared information may include shared data, the data length for identification of transfer validity of the shared data, and a return value for verifying whether data has been normally transferred.

According to an embodiment, the computing device may further include an event handler configured to detect an occurrence of an event that the master application transfers the shared information to the shared memory and transfer a result of detection of the occurrence of the event to the slave application.

According to an embodiment, in response to the occurrence of the event, the event handler may receive data structure information about the shared information from the master application and transfer the data structure information to the slave application.

According to an embodiment, when receiving a result of detection of the occurrence of the event from the event handler, the slave application may receive the shared information from the shared memory by using the second memory function.

According to an embodiment, the slave application may identify valid transfer of the shared information, based on the shared information and the data structure information, and transfer a result of identification of the valid transfer to the event handler.

According to an embodiment, when the shared information has been validly transferred based on the shared information and the data structure information, the slave application may delete the shared information stored in the shared memory by calling a third memory function. According to an embodiment, the master application may delete, by using a third memory function, the shared information stored in the shared memory.

According to various embodiments of the present disclosure, a method of performing data communication between a plurality of applications by using an API includes transferring, by a master application, shared information to a shared memory by using a first memory function, transferring, by the shared memory, the shared information to a slave application, and receiving, by the slave application, the shared information from the shared memory by using a second memory function.

According to an embodiment, the shared information may include shared data, the data length for identification of transfer validity of the shared data, and a return value for verifying whether data has been normally transferred.

According to an embodiment, the method may further include, when the master application transfers the shared information to the shared memory, detecting, by an event handler, an occurrence of an event and transfer, by the event handler, a result of detection of the occurrence of the event to the slave application.

According to an embodiment, the method may further include, in response to the occurrence of the event, receiving, by the event handler, data structure information about the shared information from the master application, and transferring, by the event handler, the data structure information to the slave application.

According to an embodiment, the method may further include, when receiving a result of detection of the occurrence of the event from the event handler, receiving, by the slave application, the shared information from the shared memory by using the second memory function.

According to an embodiment, the method may further include identifying, by the slave application, valid transfer of the shared information, based on the shared information and the data structure information, and transferring, by the slave application, a result of identification of the valid transfer to the event handler.

According to an embodiment, the method may further include, when the shared information has been validly transferred based on the shared information and the data structure information, deleting, by the slave application, the shared information stored in the shared memory by calling a third memory function.

Various respective aspects and features of the present invention are defined in the appended claims. Combinations of the characteristics of dependent claims can be appropriately combined with the characteristics of independent claims, not just explicitly presented in the claims.

Furthermore, one or more characteristics selected from any one embodiment described in the disclosure may be combined with one or more characteristics selected from other embodiments described in the disclosure, and an alternative combination of the characteristics may at least partially reduce one or more technical problems discussed in the disclosure, or technical problems discernable by a typical technician from the disclosure, and furthermore, a particular combination or permutation of embodiment features is possible unless understood by the typical technician as being incompatible.

In any described example implementation described in the disclosure, two or more physically separate constituent elements may be alternatively integrated into a single constituent element, if the integration is possible, and when the same function is performed by the single constituent element, the integration is possible. Reversely, the single constituent element of any embodiment described in the disclosure may be alternatively implemented, if appropriate, as two or more separate constituent elements performing the same function.

The purpose of certain embodiments of the present invention is to at least partially solve, reduce, or remove at least one of problems and/or disadvantages related to the related art. Certain embodiments are to provide at least one of the advantages described below.

### Advantageous Effects

In apparatuses and methods according to various embodiments of the present disclosure, as a computing device using an application programming interface (API) uses a shared memory, data communication may be performed between a plurality of applications.

Furthermore, according to the present disclosure, when data is shared between a plurality of applications, the data is controlled to be shared through a shared memory, without passing through a main controller, the complexity in the implementation of a main controller may be reduced, and a communication structure may be simplified.

Furthermore, according to the present disclosure, as data is controlled to be shared through a shared memory, without passing through a main controller, the communication time may be reduced.

Furthermore, according to the present disclosure, by checking whether pieces of data shared through a shared memory have been validly transferred, communication accuracy may be improved.

The effects of the present disclosure are not limited to the above-described effects, and other various effects that are not described in the specification may be clearly understood from the following descriptions by one skilled in the art to which the present disclosure belongs.

### DESCRIPTION OF DRAWINGS

FIG. 1 illustrates a communication system of a computing device according to various embodiments of the present disclosure.

FIG. 2 is a schematic view showing a data sharing method between a plurality of applications according to the related art.

FIG. 3 is a schematic view showing a data sharing method between a plurality of applications, according to various embodiments of the present disclosure.

FIG. 4 illustrates the configuration of a computing device according to various embodiments of the present disclosure.

FIG. 5 illustrates the configuration of a memory in a computing device according to various embodiments of the present disclosure.

FIG. 6 is a flowchart of a data sharing method between a plurality of applications, according to various embodiments of the present disclosure.

FIG. 7 is a flowchart of an operating method of a computing device, according to various embodiments of the present disclosure.

### MODE FOR INVENTION

The terms used in the specification are merely used to describe embodiments, and are not intended to limit the disclosure. An expression used in the singular encompasses the expression of the plural, unless it has a clearly different meaning in the context. Unless defined otherwise, all terms used herein including technical or scientific terms have the same meanings as those generally understood by those of ordinary skill in the art to which the disclosure may pertain. The terms as those defined in generally used dictionaries are construed to have meanings matching that in the context of related technology and, unless clearly defined otherwise, are not construed to be ideally or excessively formal. In some cases, even a term defined in the present disclosure cannot be construed to exclude embodiments of the present disclosure.

In various embodiments of the present disclosure described below, a hardware-based approach method is explained as an example. However, since various embodiments of the present disclosure include technology using both hardware and software, the various embodiments of the present disclosure do not exclude software-based approaches.

The present disclosure presented below relates to an apparatus and method of performing data communication between a plurality of applications by using an application programming interface (API). In detail, the present disclosure describes technology to share data between a plurality of applications by using a shared memory

The embodiment of the disclosure is described with reference to the accompanying drawings so that one skilled in the art to which the disclosure pertains can easily implement the disclosure. However, the disclosure is not limited thereto and it will be understood that various changes in form and details may be made therein. In the following description, when detailed descriptions about related well-known functions or structures are determined to make the gist of the disclosure unclear, the detailed descriptions will be omitted herein. The same or corresponding constituents are indicated by the same reference numerals and redundant descriptions thereof are omitted

It will be understood that when a component is referred to as being “connected to” another component, it can be directly connected to the other component or indirectly connected to the other component via intervening components. It will be further understood that the terms “comprises” and/or “comprising” used herein specify the presence of stated features or components, but do not preclude the presence or addition of one or more other features or components.

The disclosure may be described in terms of functional block components and various processing steps. Some or all of such functional blocks may be realized by any number of hardware and/or software components configured to perform the specific functions. For example, the functional blocks of the present disclosure may be implemented by one or more microprocessors, or by circuit configurations for a predetermined function. Furthermore, for example, the functional blocks of the present disclosure may be implemented in various programming or scripting languages. The functional blocks may be implemented as algorithms running on one or more processors. A function performed by a functional block in the present disclosure may be performed by a plurality of functional blocks, or functions performed by a plurality of functional blocks in the present disclosure may be performed by a single functional block. Furthermore, the present disclosure may employ conventional technologies for electronic environment setup, signal processing, and/or data processing.

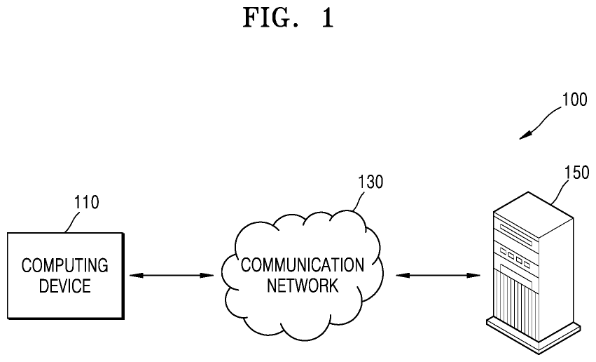

FIG. 1 illustrates a communication system 100 of a computing device according to various embodiments of the present disclosure. Referring to FIG. 1, the communication system 100 may include a computing device 110, a communication network 130, and a server 150.

The computing device 110 may refer to an embedded device capable of transceiving data with the server 150. The computing device 110 may be connected to the communication network 130, and may transfer data to the server 150 or receive data from the server 150 through the communication network 130. The computing device 110 may execute at least one application by using an API. According to an embodiment of the present disclosure, at least one application may include applications performing various functions, such as an application for obtaining data of the computing device 110, an application for processing data, an application for transferring data, and the like. The computing device 110 may transceive or process data by using at least one application.

According to an embodiment of the present disclosure, the computing device 110 may include a network camera operated in a multi-channel. The network camera may execute at least one application and obtain, process, and transceive information about an image by using at least one application. The number and shape of the computing device 110 illustrated in FIG. 1 are examples, but the disclosure is not limited thereto.

The server 150 may refer to an apparatus that obtains and processes data through the communication network 130. The server 150 may obtain data from the computing device 110 through the communication network 130. Furthermore, the server 150 may store data obtained according to a user's operation or transfer data to another computing device. According to an embodiment of the present disclosure, the server 150 may refer to a storage device that shares data with the computing device 110 in a network camera system.

The computing device 110 may execute a plurality of applications to process and transceive data. The computing device 110 may obtain data by using a plurality of applications and directly process the data. In this state, there may be a demand for data sharing between a plurality of applications executed by the computing device 110. To this end, the computing device 110 may share data by using a shared memory between the applications. Hereinafter, a method of sharing an application data by using a shared memory is described in detail.

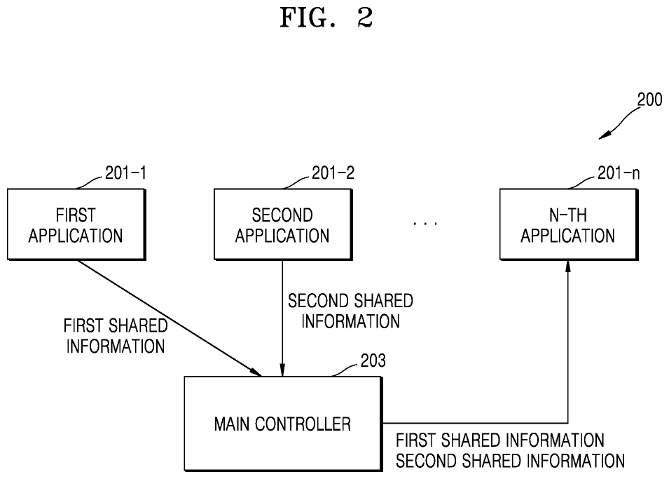

FIG. 2 is a schematic view 200 illustrating a data sharing method between a plurality of applications according to the related art. FIG. 2 shows an example of an operating method of the computing device 110 of FIG. 1.

Referring to FIG. 2, the computing device 110 may execute a plurality of applications. The applications executed by the computing device 110 may generate data to perform a desired function and share data between the applications, as necessary. In this state, the computing device 110 may control data sharing by using a main controller 203.

According to an embodiment of the present disclosure, the computing device 110 may execute a first application to an n-th application 201-1 to 201-n. The first application 201-1 may generate first shared information to share data with the n-th application 201-n. The second application 201-2 may also generate second shared information to share data with the n-th application 201-n. The first application 201-1 and the second application 201-2 may respectively transfer the generated first shared information and second shared information to the n-th application 201-n through the main controller 203.

According to the related art, the first shared information and the second shared information are transferred through the main controller 203 in a process of transferring the information from the first application 201-1 and the second application 201-2 to the n-th application 201-n. In this state, the main controller 203 is controlled by a central processing module of the computing device 110, and socket communication is used therefor. In other words, the main controller 203 receives the first shared information and the second shared information from the first application 201-1 and the second application 201-2 by using socket communication, and transfers the information directly to the n-th application 201-n. The communication method in which information is transferred through the main controller 203 uses socket communication so that the communication time is long. Furthermore, it is a problem that the structure of the central processing module of the computing device 110 according to data processing in a process in which shared information passes through the main controller 203 becomes complicated.

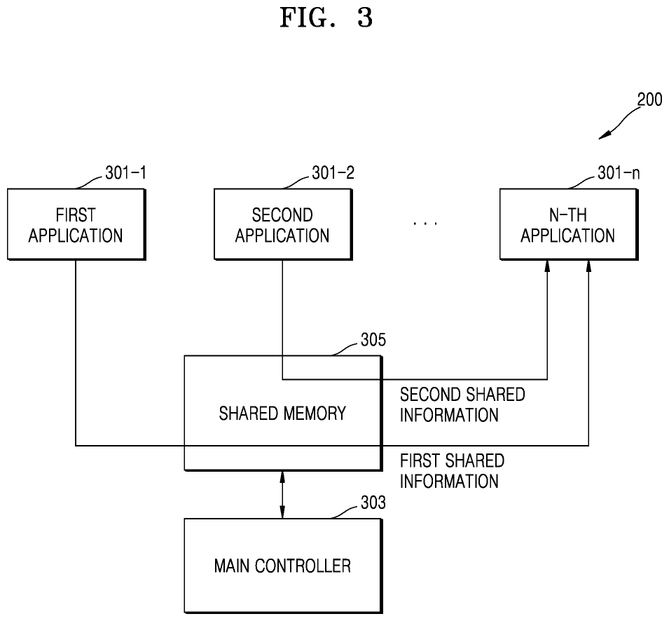

FIG. 3 is a schematic view 300 showing a data sharing method between a plurality of applications, according to various embodiments of the present disclosure. FIG. 3 illustrates an example of an operating method of the computing device 110 of FIG. 1.

Referring to FIG. 3, the computing device 110 may execute a plurality of applications, and the applications may share data as necessary data. In this state, the computing device 110 may control data sharing by using a shared memory 305. In other words, the computing device 110 may further include the shared memory 305 connected between a main controller 303 and the applications, and shared information between the applications may be directly shared through the shared memory 305, without passing through the main controller 303.

According to an embodiment of the present disclosure, the computing device 110 may execute first to n-th applications 301-1 to 301-n. The first application 301-1 may generate first shared information to share data with the n-th application 201-n. The second application 301-2 may also generate second shared information to share data with the n-th application 301-n. The first application 301-1 and the second application 301-2 may respectively transfer the generated first shared information and second shared information to the n-th application 301-n via the main controller 303.

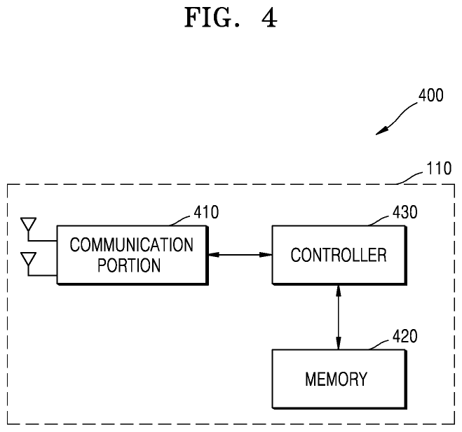

According to the present disclosure, the first shared information and the second shared information may be transferred through the shared memory 305, without passing through the main controller 303, in a process of transferring the information from the first application 301-1 and the second application 301-2 to the n-th application 301-n. In other words, in a data transmission process between the applications, as the shared information doss not pass through the main controller 303 that uses socket communication, the communication time may be reduced. Furthermore, as a modification is not required in the configuration of an additional main controller, the structure of the central processing module may be simplified. The method of transferring shared information by using the shared memory 305 without passing through the main controller 303 is described in detail with reference to FIGS. 4 to 7.

FIG. 4 illustrates a configuration 400 of the computing device 110 according to various embodiments of the present disclosure. Terms such as “ . . . portion,” “ . . . unit,” and the like stated in the specification may signify a unit to process at least one function or operation and the unit may be embodied by hardware, software, or a combination of hardware and software

The computing device 110 may execute a plurality of applications in the API. The computing device 110 may perform a desired operation by using a plurality of applications. The plurality of applications may share data by using a shared memory. Referring to FIG. 4, the computing device 110 may include a communication portion 410, a memory 420, and a controller 430.

The communication portion 410 performs functions to transceive data with other network devices through a wired or wireless channel connection. The whole or part of the communication portion 410 may be referred to as a transferring portion, a receiving portion, or a transceiving portion, and may be a device including hardware and software needed to transceive data.

The memory 420 performs a function of storing data of a basic program, an application program, a setting information, and the like for the operation of the computing device 110. The memory 420 may include a volatile memory, a non-volatile memory, or a combination of a volatile memory and a non-volatile memory. The memory 420 may provide stored data or write data according to a request of the controller 430.

When a plurality of applications are executed, the memory 420 may store data generated by each of the applications. According to an embodiment of the present disclosure, the memory 420 may include an application memory for storing data generated by a plurality of applications. The memory 420 may include a shared memory for sharing data between a plurality of applications. According to an embodiment of the present disclosure, the memory 420 may further include an event handler for detecting occurrence of an event according to the executing of a plurality of applications and transceiving a detection result.

The controller 430 controls all operations of the computing device 110. For example, the controller 430 may transfer and receive a signal or write data to the memory 420 through the communication portion 410. According to various embodiments of the present disclosure, the controller 430 may include a main controller as a central processing module. According to an embodiment of the present disclosure, the main controller may execute an application program under the control of an operating system. The main controller may control the execution and operation of a program.

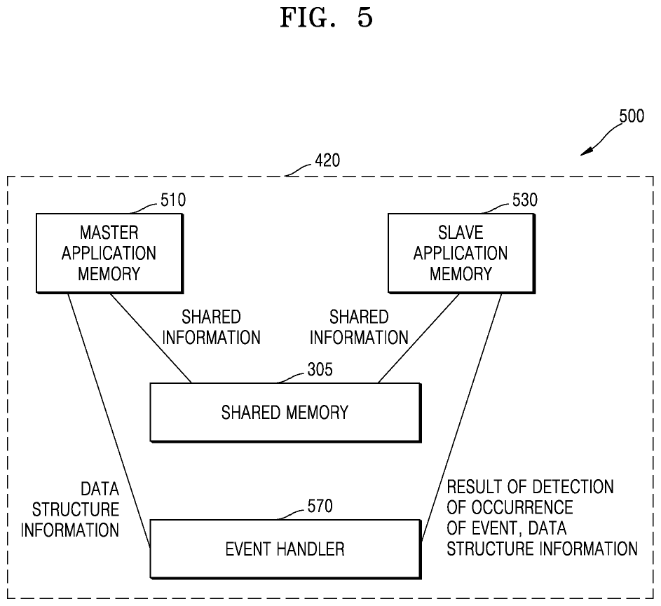

FIG. 5 illustrates the configuration 500 of a memory in the computing device 110 according to various embodiments of the present disclosure. FIG. 5 illustrates an example of the configuration of the memory 420 of FIG. 4.

The memory 420 refers to a device that is connected to the main controller of the controller 430 and performs a function of storing data. The computing device 110 may execute a plurality of applications and control data sharing between the plurality of applications. Referring to FIG. 5, the memory 420 may include a master application memory 510 that refers to an area where data generated by a master application is stored, a slave application memory 530 that refers to an area where the data generated by a slave application is stored, and the shared memory 305 connected between the master application memory and the slave application memory and transferring shared information between the master application and the slave application. The master application may refer to an application that transfers shared information, and the slave application may refer to an application that receives the shared information. Additionally, the memory 420 may further include an event handler 570 that operates in response to a transceiving event of shared information. Although FIG. 5 illustrates a case in which the event handler 570 is arranged inside the memory 420, the event handler 570 may be designed to be arranged outside the memory 420 and perform the same function as that described below.

According to an embodiment of the present disclosure, the master application stored in the master application memory 510 may call a first memory function and transfer shared information to the shared memory 305 by using the first memory function. According to an embodiment of the present disclosure, the first memory function may include functions of receiving data, a data length for data validity identification, and a return value for verifying whether data has been normally transferred, and transferring the data. Accordingly, the shared information may include shared data, the length of shared data, and a return value. The shared information stored in the master application memory 510 may be transferred to the shared memory 305 according to the first memory function.

The slave application stored in the slave application memory 530 may call a second memory function and receive shared information from the shared memory 305 by using the second memory function. According to an embodiment of the present disclosure, the second memory function may include a function of receiving shared information stored in a shared memory. When the shared information is transferred to the shared memory 305, the event handler 570 may detect occurrence of an event that the master application transfers shared information. The event handler 570 may detect occurrence of an event and notify a result of the occurrence of an event to the slave application. In response thereto, the slave application may confirm that the shared information is stored in the shared memory 305 and call the second memory function. The shared information stored in the shared memory 305 may be transferred to the slave application memory 530 according to the second memory function.

The event handler 570 performs functions of detecting the occurrence of an event that the master application transfers the shared information to the shared memory 305 and providing the slave application with a result of the detection of the occurrence of an event. Additionally, in order to improve the accuracy of identifying valid delivery of shared information, the event handler 570 may receive data structure information from the master application memory 510. The data structure information is information referring to a structure of shared data, which may be used, with the data length, for determining whether data has been normally transferred. When generating an event of storing shared information in a shared memory, the master application may transfer data structure information to the event handler 570, and the event handler 570 may transfer data structure information to the slave application, with a result of the detection of the occurrence of an event. In response thereto, the slave application may transfer the shared information stored in the shared memory 305 to the slave application memory 530 and identify valid transfer.

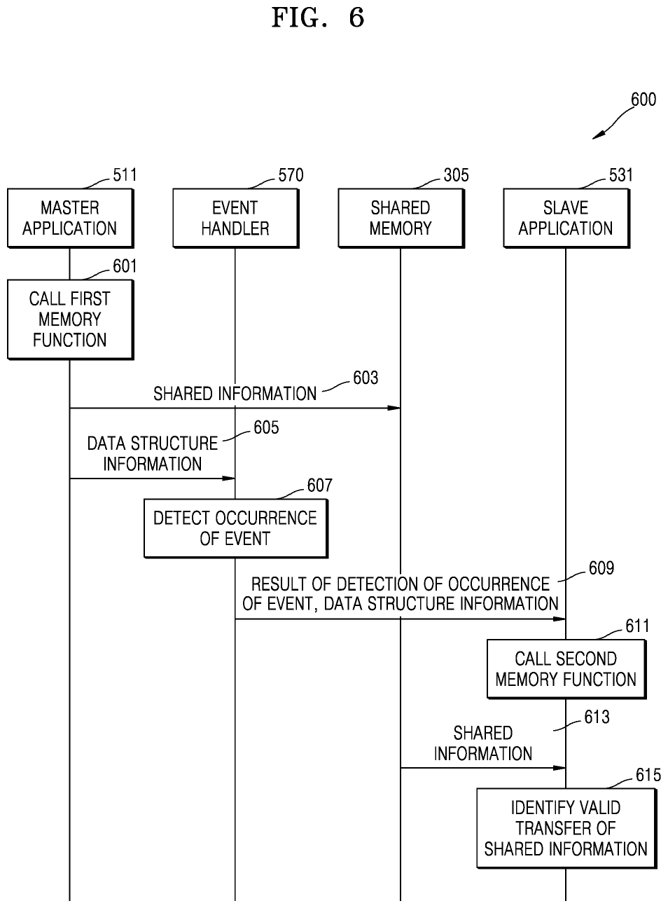

FIG. 6 is a flowchart 600 of a data sharing method between a plurality of applications, according to various embodiments of the present disclosure. FIG. 6 illustrates an example of a method of transferring information between the components of the memory 420 included in the computing device 110.

Referring to FIG. 6, in operation 601, a master application 511 calls a first memory function. The master application 511 may call the first memory function to transmit shared information to a slave application 531. According to an embodiment of the present disclosure, the first memory function may include a function to perform a function of receiving data, a data length, and a return value and transferring shared information from the master application memory 510 to the shared memory 305.

In operation 603, the master application 511 transfers shared information to the shared memory 305. The master application 511 may transfer shared information to the shared memory 305 by using the first memory function. According to an embodiment of the present disclosure, the shared information may include shared data, a data length for shared data validity identification, and a return value for verifying whether data has been normally transferred.

In operation 605, the master application 511 may transfer data structure information to the event handler 570. According to an embodiment of the present disclosure, the master application 511 may transfer data structure information to the event handler 570 while transferring shared information to the shared memory 305.

In operation 607, the event handler 570 detects an occurrence of an event. According to an embodiment of the present disclosure, the event handler 570 may detect occurrence of an event that the master application 511 transfers shared information to the shared memory 305. Although FIG. 6 illustrates a case in which, after the master application 511 transfers data structure information to the event handler 570, the event handler 570 detects an occurrence of an event, the order of operation 605 and operation 607 may be changed. In other words, when the shared information is transferred to the shared memory 305, the event handler 570 may detect an occurrence of an event and then receive data structure information from the master application 511.

In operation 609, the event handler 570 transfer a result of the detection of an occurrence of an event and the data structure information to the slave application 531. According to an embodiment of the present disclosure, the event handler 570 may transfer, to the slave application 531, a detection result indicating that the shared information is stored in the shared memory 305. Furthermore, the event handler 570 may transfer the data structure information received from the master application 511 to the slave application 531.

In operation 611, the slave application 531 calls a second memory function. The slave application 531 may receive a result of the detection of an occurrence of an event and call a second memory function in response thereto. According to an embodiment of the present disclosure, the second memory function may include a function to perform a function of receiving the data stored in the shared memory 305.

In operation 613, the shared memory 305 transfers the shared information to the slave application 531. The slave application 531 may receive the shared information from the shared memory 305 by using the second memory function. According to an embodiment of the present disclosure, the slave application 531 may request the shared information from the shared memory 305 through the second memory function, and may receive the shared information from the shared memory 305.

In operation 615, the slave application 531 may identify a valid transfer of the shared information. The slave application 531 identifies whether the shared information has validly transferred based on the received shared information and data structure information. According to an embodiment of the present disclosure, the slave application 531 may confirm whether the shared information has been validly transferred by checking the data length and the data structure in the received shared data.

In addition, the slave application 531 may transfer a result of the identifying the valid transfer to the event handler 570. The slave application 531 may provide the event handler 570 with information about whether the shared information has been normally transferred, and the event handler 570 may provide the master application 511 with information about whether the shared information has been normally transferred. Accordingly, the master application 511 may confirm that the shared information has been normally transferred to the slave application 531, based on the information about whether the shared information has been normally transferred, which is received from the event handler 570. Then the master application 511 may call a third memory function to delete the shared information stored in the shared memory 305. As the size of the shared memory 305 is definite, the master application 511 may perform an operation to delete the shared information for management of the shared memory 305.

According to another embodiment the slave application 531 may confirm whether the shared information has been validly transferred, by checking the data length and the data structure in the received shared data. When the shared information has been validly transferred, the slave application 531 may call the third memory function to delete the shared information stored in the shared memory 305.

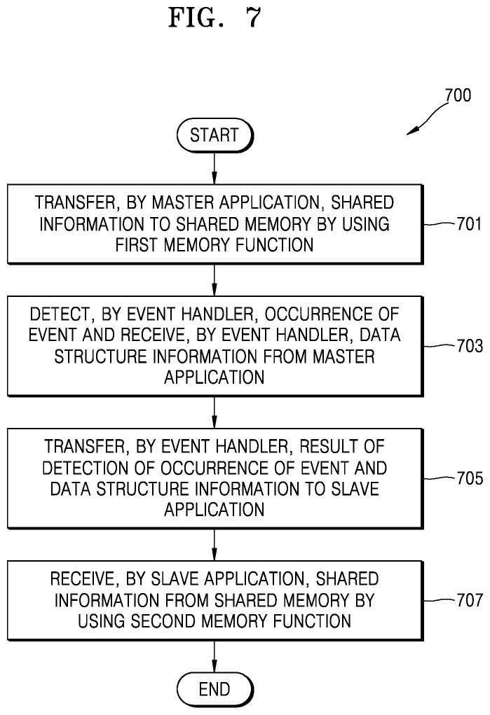

FIG. 7 is a flowchart 700 of an operating method of a computing device 110, according to various embodiments of the present disclosure. FIG. 7 illustrates an operating method of the computing device 110 to perform data communication between a plurality of applications by using the API. In detail, FIG. 7 shows an example of a method of sharing data between components of the memory 420 included in the computing device 110.

Referring to FIG. 7, in operation 701, the master application 511 transfers shared information to the shared memory 305 by using the first memory function. The master application 511 may call the first memory function to transfer the shared information to the slave application 531, and transfer the shared information to the shared memory 305 by using the first memory function. According to an embodiment of the present disclosure, the shared information may include shared data, a data length for shared data validity identification, and a return value for verifying whether data has been normally transferred.

In operation 703, the event handler 570 may detect an occurrence of an event and receive data structure information from the master application 511. According to an embodiment of the present disclosure, the event handler 570 may detect an occurrence of an event that the master application 511 transfers the shared information to the shared memory 305. Furthermore, the event handler 570 may receive data structure information about the shared information from the master application 511. The data structure information may include information indicating the structure of shared data.

In operation 705, the event handler 570 transfers, to the slave application 531, a result of the detection of an occurrence of an event and the data structure information. According to an embodiment of the present disclosure, the event handler 570 may transfer a result of the detection indicating an occurrence of an event to the slave application 531. Furthermore, the event handler 570 may transfer the data structure information to the slave application 531.

In operation 707, the slave application 531 receives the shared information from the shared memory 305 by using the second memory function. The slave application 531 may call the second memory function in response to the reception of the result of the detection of an occurrence of an event from the event handler 570. Then the slave application 531 may receive the shared information from the shared memory 305 by using the second memory function.

Then, the slave application 531 may identify a valid transfer of shared information based on the received shared information and data structure information. The slave application 531 may confirm whether the shared data has been normally transferred by checking the data length and the data structure information. The slave application 531 may transfer, to the event handler 570, a result of the identification of the valid transfer of shared information. In response thereto, the event handler 570 may transfer, to the master application 511, information about whether the shared information has been normally transferred. Accordingly, the master application 511 may identify that the shared information has been normally transferred to the slave application 531.

Then the master application 511 may delete the shared information stored in the shared memory 305 by using the third memory function. The master application 511 may call the third memory function for the management of the shared memory 305. Accordingly, the shared information stored in the shared memory 305 may be deleted.

The methods according to the embodiments described in the claims or specification of the present disclosure may be implemented by hardware, software, or a combination of hardware and software.

When the method is implemented by software, a computer-readable storage medium having stored one or more programs (software module) therein may be provided. The one or more programs stored in the computer-readable storage medium are configured to be executed by one or more processors in an electronic device. The one or more programs may include instructions to perform, by an electronic device, the methods described in the claims or specification of the present disclosure.

The program (software module or software) may be stored in random access memory (RAM), non-volatile memory including flash memory, read only memory (ROM), electrically erasable programmable read only memory (EEPROM), magnetic disc storage devices, optical storage devices in the form of compact disc-ROMs, CD-ROMs, digital versatile discs (DVDs), or the like, and magnetic cassettes. Alternatively, the program may be stored in a memory configured with a combination of some or all thereof. Furthermore, each component memory may include a plurality of memories.

Furthermore, the programs may be stored in attachable storage devices to be accessible through a communication network, such as the Internet, Intranet, a local area network (LAN), a wide area network (WAN), a storage area network (SAN), or a combination thereof. The storage device may be connected to a device that performs an embodiment of the present disclosure through an external port. Furthermore, a separate storage device on a communication network may be connected to a device that performs an embodiment of the present disclosure.

In the specific embodiments of the present disclosure described above, a component included in the disclosure is expressed in a singular or plural form according to the disclosed specific embodiment. However, the singular or plural expression is selected suitable for the disclosed situation, for convenience of explanation, the present disclosure is not limited to a singular or plural components, and a component expressed in a plural form may include a single component, whereas a component expressed in a singular form may include a plurality of components.

Meanwhile, in the detailed description of the present disclosure, specific embodiments have been described, but various modifications are possible without departing from the scope of the present disclosure. Therefore, the scope of the present disclosure should not be limited to the described embodiments, but should be determined not only by the scope of the claims described later, but also by equivalents to the scope of the claims.

1. A computing device for performing data communication between a plurality of applications by using an application programming interface (API), the computing device comprising:
a first application memory storing a master application that transfers shared information to a shared memory by using a first memory function;
a second application memory storing a slave application that receives the shared information from the shared memory by using a second memory function; and
the shared memory connected between the first application memory and the second application memory and configured to transfer the shared information between the master application and the slave application.

2. The computing device of claim 1, wherein the shared information comprises shared data, a data length for identification of transfer validity of the shared data, and a return value for verifying whether data has been normally transferred.

3. The computing device of claim 1, further comprising an event handler configured to detect an occurrence of an event that the master application transfers the shared information to the shared memory and transfer a result of detection of the occurrence of the event to the slave application.

4. The computing device of claim 3, wherein, in response to the occurrence of the event, the event handler receives data structure information about the shared information from the master application and transfers the data structure information to the slave application.

5. The computing device of claim 3, wherein, when receiving a result of detection of the occurrence of the event from the event handler, the slave application receives the shared information from the shared memory by using the second memory function.

6. The computing device of claim 5, wherein the slave application identifies valid transfer of the shared information, based on the shared information and the data structure information, and transfers a result of identification of the valid transfer to the event handler.

7. The computing device of claim 6, wherein, when the shared information has been validly transferred based on the shared information and the data structure information, the slave application deletes the shared information stored in the shared memory by calling a third memory function.

8. The computing device of claim 1, wherein the master application deletes, by using a third memory function, the shared information stored in the shared memory.

9. A method of performing data communication between a plurality of applications by using an application programming interface (API), the method comprising:
transferring, by a master application, shared information to a shared memory by using a first memory function;
transferring, by the shared memory, the shared information to a slave application; and
receiving, by the slave application, the shared information from the shared memory by using a second memory function.

10. The method of claim 9, wherein the shared information comprises shared data, a data length for identification of transfer validity of the shared data, and a return value for verifying whether data has been normally transferred.

11. The method of claim 9, further comprising, when the master application transfers the shared information to the shared memory, detecting, by an event handler, an occurrence of an event and transfer, by the event handler, a result of detection of the occurrence of the event to the slave application.

12. The method of claim 11, further comprising:
in response to the occurrence of the event, receiving, by the event handler, data structure information about the shared information from the master application; and
transferring, by the event handler, the data structure information to the slave application.

13. The method of claim 11, further comprising, when receiving a result of detection of the occurrence of the event from the event handler, receiving, by the slave application, the shared information from the shared memory by using the second memory function.

14. The method of claim 13, further comprising:
identifying, by the slave application, valid transfer of the shared information, based on the shared information and the data structure information; and
transferring, by the slave application, a result of identification of the valid transfer to the event handler.

15. The method of claim 14, further comprising, when the shared information has been validly transferred based on the shared information and the data structure information, deleting, by the slave application, the shared information stored in the shared memory by calling a third memory function.
